(19) United States
(12) Patent Application Publication
(10) Pub. No.: US 2002/0029089 A1
(43) Pub. Date: Mar. 7, 2002

(54) Receiving device, data broadcast receiving system, content accessing method, and program thereof

(76) Inventor: Eiji Ueda, Hiroshima-ken (JP)

Correspondence Address: MCDERMOTT, WILL & EMERY, 600 13th Street, N.W., Washington, DC, 20005-3096, US

(21) Appl. No.: 09/939,789

(22) Filed: Aug. 28, 2001

(30) Foreign Application Priority Data
Aug. 28, 2000 (JP) 2000-256911

(51) Int. Cl. G06F 17/00

(52) U.S. Cl. 700/94; 709/231

(57) ABSTRACT

The invention can provide receiving device, data broadcasting receiving system, content accessing method, and program thereof, that can settle problems of URL transfer and route, and makes a user arrive at content that is an object of a user in a simple way.

The broadcasting receiving means receives broadcasting data in which content deciding data deciding a position of content placed on the network is multiplexed with broadcasting program associated with the content. And then the demultiplexing means demultiplexes the content deciding data and the broadcasting program from the broadcasting data, and the data communication means accesses to the content according to the demultiplexed content deciding data.

### BACKGROUND OF THE INVENTION

1. Field of the Invention

This invention relates to receiving device and data broadcasting receiving system, and more specifically to a receiving device, a data broadcasting receiving system, a content accessing method and its program, those which access to content on the network by means of content deciding data multiplexed with a broadcasting program.

2. Prior Art of the invention

In recent years, the utilization of the Internet (the network) becomes popular and the use spreads wide. Particularly, the Internet is utilized frequently for browsing content representative of homepage and for exchanging e-mails. In addition, the frequency of the utilization of the Internet by means of a mobile phone gets increase recently. And now the utilization of the Internet by means of a mobile phone gets indispensable for user's communication.

On the other hand, a standing type television, which is able to utilize the Internet, is getting to be diffused, and it is possible for the standing type television to access to content on the Internet. Since such standing type television shares many parts with the above mobile phone, it is expected in future that such television will be downsized and integrated with the mobile phone.

And now, there is a conventional subject that is a method of inputting URL (Uniform Resource Locater) at the time of utilizing the Internet. That is to say, when a user displays a homepage (content) or sends e-mail, he never fails to indicate the position information of the content on the Internet. Therefore, a content-provider has two subjects in order that the content gets high audience rating; that is to say, how to make a user input the URL, and how to provide or propose a user with the URL: the former is the subject about a method, the latter is the subject about the frequency.

First of all, the methods of inputting the URL are considered here. For instance, it is general in a personal computer that URL inputted by a keyboard provided with a plurality of keys, meanwhile the mobile phone adopts a method of inputting the URL by means of ten numerical keys allocated letters (alphabets). However, there is no telling that such method is always efficient. This is because a user always has to press many times a same numerical key in order to input one alphabet. Therefore, another method replacing the alphabets inputting is suggested.

The first one is a menu selecting method, of which the typical example is a link list prepared in advance by a provider company of the mobile phone. The link list is a menu registering a plurality of content addresses. Since the link list was prepared in advance, when a user uses the mobile phone, he simply displays the menu and selects a desired URL from the menu; thereby the user can browse the content being an object instead of inputting the URL.

The second one is a numerals inputting method, which allocates a specific numeral string to a URL. In order to utilize the method, a user has to access to a specific homepage and use the database provided by the site. Specifically, it is configured that the user inputs as a search key a numeral string into the searching function provided by the specific homepage, thereby the corresponding content is displayed. Therefore the user can simply input by numeral keys and browse the content, without a troublesome operation of inputting alphabets.

The third one is a barcode inputting method, which allocates a specific barcode to a URL. In order to utilize the method, a user has to access to a specific homepage and use the database provided by the site. Specifically, it is configured that the user inputs a result of reading the barcode into the searching function provided by the specific homepage, thereby the corresponding content is displayed. Therefore the user can browse the content without a complicated operation of inputting by keys.

The fourth one is a keyword inputting method, which allocates a specific keyword to a URL. Like a case of utilizing the homepage provided with the conventional searching engine, a user has to access to a specific homepage and use the database provided by the site. Specifically, it is configured that the user inputs a keyword into the searching function provided by the specific homepage, thereby the corresponding content can be browsed. In addition, it has been proposed a method of inputting direct a keyword instead of the URL. Therefore the user can browse the content by inputting a significant character string instead of unfamiliar characters or numerals.

The fifth one is a multi-language inputting method, which is to input URL represented by languages other than English. For instance, by inputting “http:// [symbol] ◯ Δ .com” worded in Japanese instead of “http://bookstore◯Δ.com” in English that is not familiar to a Japanese user, the Japanese user can browse the corresponding homepage.

All of the above-mentioned ideas can be considered as a method of accessing to a database preparing keywords corresponding to URL. Either of the methods do not need to input the URL direct, but other methods except the first one need to input something instead of URL. Therefore, the following problems still remain.

There is a problem of transferring URL; that is to say, it may happen that a user inputs a wrong URL, as the user has to input the URL after he remembers it for the inputting. However, the third method of a barcode inputting will not cause such accident. But, since the method of barcode imputing must be provided with an association device such as a barcode reader, it is necessary to consider the trade-off between the erroneous input and the associating operation of the device. Beside, since most of users always browse homepages for a short time at any time, it is general that the load of the associating operation of the device is large.

In addition, in case of the first method of the menu selecting, since there are various steps to be taken in order that the content-provider publishes the URL of homepage on the menu prepared by the provider of mobile phone, it takes a lot of time in general.

And since the number of menu items is restricted with in the link list, the number of registration of homepages is also limited. In result, the menu is to publish only URL of the representative page (for example, the top page) of the homepage. Consequently, it is necessary to ensure any route to introduce a user to the homepage that the content-provider wants to exhibit. Generally, since many users lose their way while tracing linking pages from the top page of the homepage or they change their interests in other homepages, the users do not always arrive at the content the content-provider wants to exhibit. After all, the user cannot arrive the homepage being his object, that is to say, this is a problem of detour route. Particularly, when a broadcasting program makes advertisement of a product provided by a maker, a user usually utilizes the Internet to refer to the detail of the product. In such case, the user wants to display the URL of the homepage of the object product, instead of the top page of the maker; non the less, the broadcasting program displays the URL of the top page because of some reason of the display or the URL transfer problem. As a natural consequence, the problem of detour route appears remarkably.

Additionally, when the broadcasting program displays direct the URL of the homepage of the product, the user can arrive at the homepage of the product certainly. However, it is sure to reduce chances that the user visits other homepages provided by the maker (content-provider), this is a problem of direct route. It is natural that the content-provider wants to avoid such situations.

Although the input operations are simplified to some extent regarding the URL input as described above, the URL transfer problem and the problem of detour route as describe above still remain. And when the URL of the object content is displayed direct in order to resolve the problem of detour route, there is the problem of direct route that the chances for a user to visit other homepages are reduced.

Therefore, in order to settle the URL transfer problem, the problem of detour route and the problem of direct route, the invention has an object to provide a receiving device, data receiving system, content accessing method, and a program by which a user can got to an object content with ease.

### SUMMARY OF THE INVENTION

The invention adopts the following means in order to achieve the above objects. That is to say, the invention is assumed to be a receiving device receiving a broadcasting program.

Broadcasting receiving means composing the receiving device receives broadcasting data in which content deciding data is multiplexed with a broadcasting program associated with said content, the content deciding data deciding a position of content placed on the network. Demultiplexing means demultiplexes the content deciding data and the broadcasting program from the broadcasting data received by the broadcasting receiving means, and data communication means accesses to the content based on the content deciding data demultiplexed by the demultiplexing means.

In the above configuration, a use can obtain content deciding data (for example, URL) in a simple way such as by pressing one button, instead of using inputting means like a keyboard, and access to the content corresponding to the cont deciding data. Therefore, the user is not required to remember the URL for the inputting. Accordingly, it is possible to settle the above URL transfer problem.

Where there is a plurality of the content deciding data in the broadcasting data, the demultiplexing means demultiplexes a plurality of content deciding data respectively from the broadcasting data, and data management means selects one or more content deciding data from the plurality of content deciding data according to a specific condition. The data communication means accesses to the contents based on the content deciding data selected by the data management means. The specific condition may be an audio type selected by the receiving device.

In the above configuration, it is possible to change automatically the content deciding data obtained by a user according to the specific condition (for example, the audio type), and the user can obtain the content deciding data corresponding to the audio type of the broadcasting data that the user is listing and watching, and easy access to the homepage indicated by the URL.

Where there are a plurality of the content deciding data and scenario data indicating the order of using the content deciding data in the broadcasting data, the demultiplexing means demultiplexes a plurality of content deciding data and scenario data respectively from the broadcasting data. Next, data management means selects in sequence the demultiplexed plural content deciding data according to the demultiplexed scenario data, and the data communication means accesses to the contents in sequence based on the selected content deciding data.

In the above configuration, it is possible to settle the URL transfer problem, and it is possible for the intention of the content provider to make a user access to specific content. Therefore, a user is sure to get to a homepage in which he is interested. In addition, a company providing a homepage can make the user browse other homepages. In result, it is possible to resolve the route problem.

The invention may be arranged that the content deciding data be a group of keywords other than the URL.

The above receiving device may be configured as data broadcasting receiving system by being provided with two different receiving devices. The data broadcasting receiving system is provided with a first receiving device comprising the broadcasting receiving means, the demultiplexing means, data sending means for sending the content deciding data demultiplexed by the demultiplexing means, and a second receiving means comprising data sending-receiving means for accessing to the content based on the content deciding data received from the content deciding data sending means.

In this configuration, for example, where a street display is displaying a broadcasting program, and when the broadcasting program can be browsed by many and unspecified persons, it is possible to carry out the use that the many and unspecified persons can get the content deciding data by using a mobile phone. In such use, the many and unspecified persons can display the content corresponding to the broadcasting program by means of a mobile phone, for example, by pressing a button.

The above receiving device can be materialized by using a personal computer. In such case, the broadcasting receiving means, the demultiplexing means, the data communication means, the data sending means, and the data sending-receiving means can be materialized by executing the program in the computer.

### BRIEF DESCRIPTION OF THE DRAWINGS

FIG. 1 is a diagram of an image of a receiving device in the embodiment 1.

FIG. 2 is a schematic block diagram showing a configuration in a broadcasting station.

FIG. 3 is a diagram showing a data configuration of content deciding data.

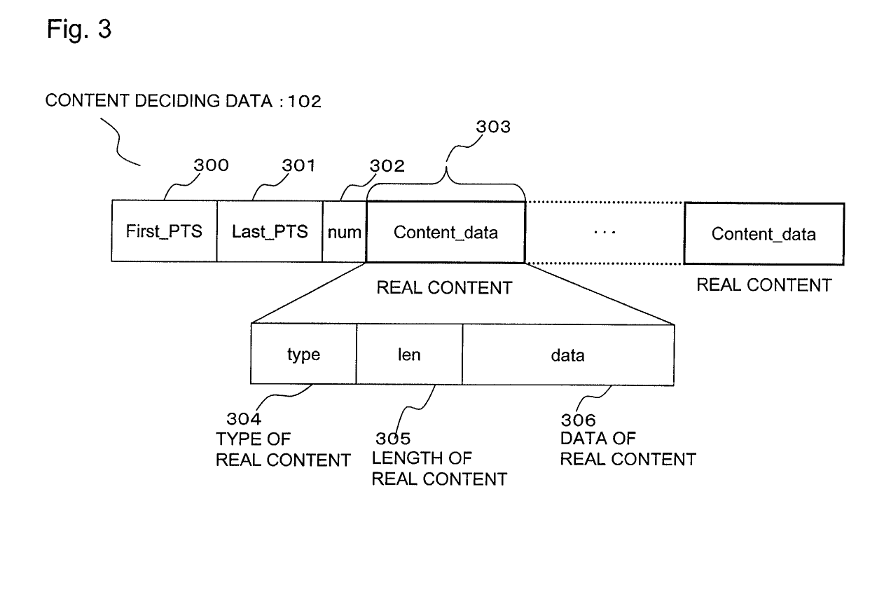

FIG. 4 is a diagram showing the association of type of real content data and data description.

FIG. 5 is a block diagram showing a configuration of a receiving device.

FIG. 6 is a flowchart showing the processing that a receiving device demultiplexes broadcasting data.

FIG. 7 is a diagram showing the association of broadcasting program and content deciding data.

FIG. 8 is a flowchart showing the processing that a receiving device obtains content deciding data and accesses to a WEB server.

FIG. 9 is a diagram showing a data configuration of content deciding data in the embodiment 2.

FIG. 10 is a diagram of an image indicating an accessed destination corresponding to each audio.

FIG. 11 is a diagram showing a data configuration of scenario data in the embodiment 3.

FIG. 12 is a diagram showing a data configuration of real content data in the embodiment 3.

FIG. 13 is a diagram of an image explaining the navigation function in the embodiment 3.

FIG. 14 is a diagram of an image of a first receiving device and a second receiving device in the embodiment 4.

FIG. 15 is a block diagram showing configurations of a first receiving device and a second receiving device.

### DESCRIPTION OF THE PREFERRED EMBODIMENTS

The following explains about the embodiments of the invention referring to the attached drawings, in order to comprehend the invention. Besides, the following preferred embodiments are one of examples materializing the invention, and not restricted to the technical field of the invention.

### Embodiment 1

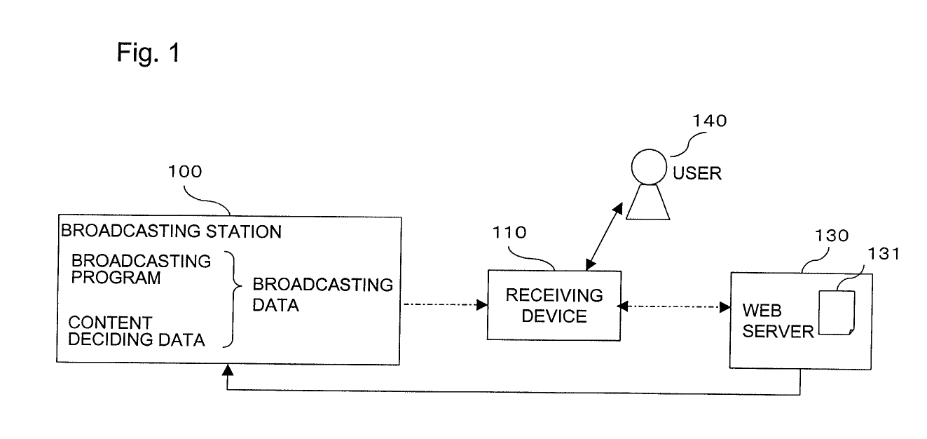

First of all, the outline of a receiving device in the embodiment 1 will be explained with reference to FIG. 1. Data broadcasting receiving system comprises a broadcasting station 100, a receiving device 110 and WEB server 130 that are connected with each other by cable or wireless.

The broadcasting station 100 multiplexes a usual broadcasting program with content deciding data associated with the broadcasting program, which is broadcasted as broadcasting data. The content deciding data associated with the broadcasting program is specifically a URL that decides the position of content placed on the network (Internet). The URL can be obtained by transfer the URL from the WEB server 130 to the broadcasting station 100. Besides, the content means information that are published on the network, for instance, the substance of text data, statistic image or moving image stored in the WEB server. There are homepages or the like applied as the representative method for publishing the content.

The receiving device 110 receives the broadcasting data broadcasted by the broadcasting station 100, and the usual broadcasting program and the content deciding data associated with the broadcasting program are displayed on a display provided with the receiving device 110.

The receiving device 110 has a function of connecting with the Internet. That is to say, it is possible for the receiving device 110 to receive the content deciding data sent from the broadcasting station 100, access to the WEB server 130 according to the content deciding data, obtain the substance of the homepage, and then display them on the display.

Here, for instance, a mobile phone is utilized to the receiving device 110, but it is not restricted to this. The receiving device may be a device including a same function as the receiving device 110. Specifically, it can be replaced with a PDA (Personal Digital Assistance) or a personal computer.

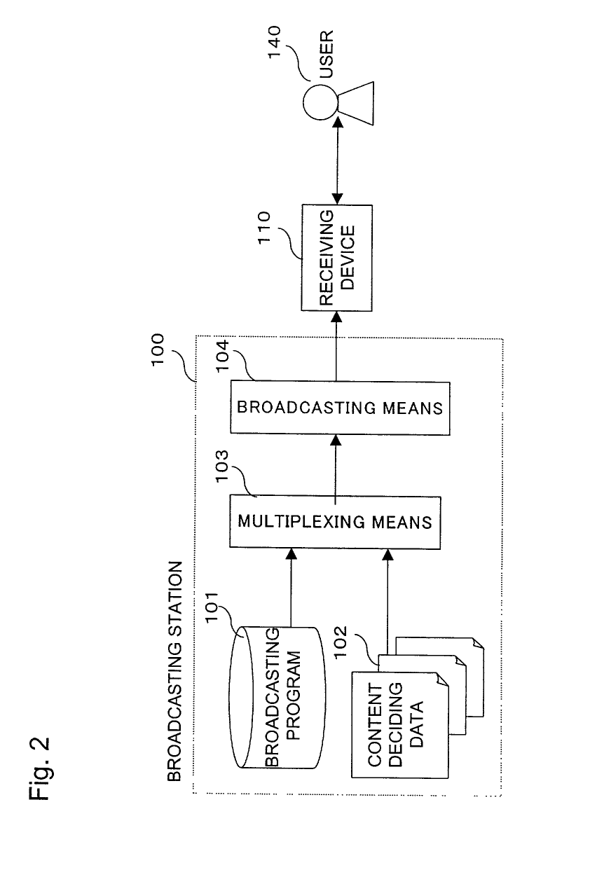

Next, the configuration of the broadcasting station 100 and the detailed processing thereof will be described here according to FIG. 2. The broadcasting station 100 combines a broadcasting program 101 and content deciding data 102 to a piece of broadcasting data by using multiplexing means 103, which is broadcasted by broadcasting means 104.

The broadcasting program 101 is video, audio, or combined data of those, which can be outputted by a usual television or radio. The content deciding data 102 is explained hereafter in detail.

That is to say, the content deciding data 102 is composed of First_PTS 300, Last_PTS 301, number of real contents (num) 302, and a plurality of real contents 303. The First_PTS 300 represents the time when the receiving device 110 starts reproducing the content deciding data 102. And the Last_PTS 301 represents the time when the receiving device 110 completes the reproduction of the content deciding data 102.

Accordingly, the content deciding data 102 can be made valid only for the time period between the First_PTS 300 and the Last_PTS 301.

Therefore, by according the reproduction time of the broadcasting program 101 to the time from the First_PTS 300 to the Last_PTS 301, a specific broadcasting program can be associated with specific content deciding data regarding the time.

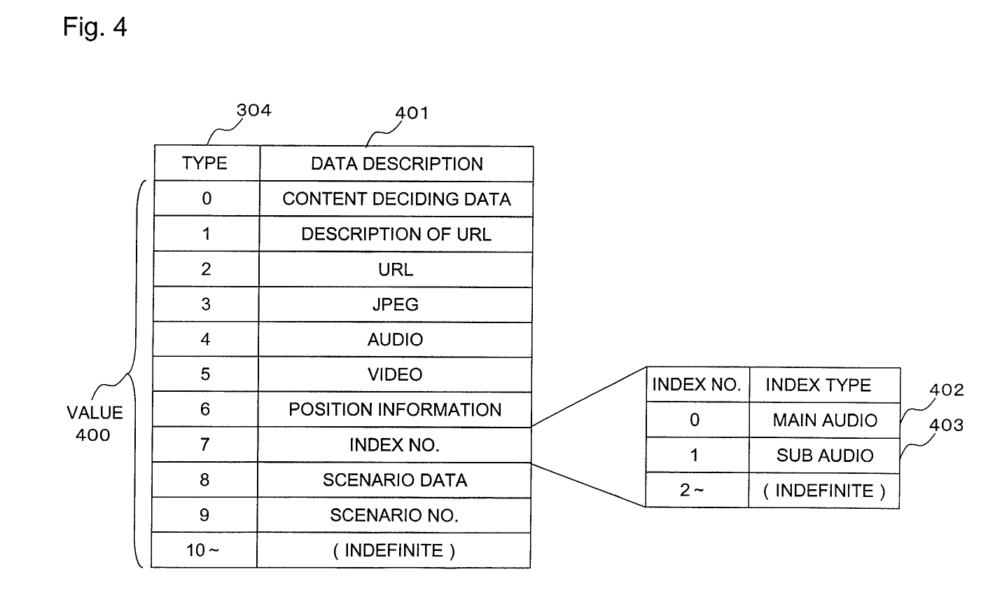

In addition, the num 302 represents the number of real contents (Content_data) included in the content deciding data 102. The real content 303 is a unit of storing real content data while the real content data varies in type as shown as type 304 in FIG. 4. Besides, the using method of the real content data will be described later.

The real content is composed of type of real content (type) 304, length of real content (len) 305, and data of real content (data) 306. The type of real content 304 represents a data type of the real content data 306, and the length of real content 305 represents a data length of the real content data 306 by a unit of byte. The real content data 306 is a substance of multimedia content.

The values stored in the type 304 may be represented specifically by a value 400 shown in FIG. 4, for example, and is defined as follows.

That is to say,

i) in case where type 304=0, the data description 401 represents the “content deciding data”. In this case, the real content data has the same format as that of the content deciding data.

ii) in case where type 304=1, the data description 401 represents a “description of URL”. The description of URL is a sentence for explaining the URL when a user cannot understand what the characters string of the URL indicates.

iii) in case where type 304=2, the data description 401 represents a “URL”.

iv) in case where type 304=3, the data description 401 represents “JPEG (Joint Photographic Experts Group)”. The JPEG is a general image format.

v) in case where type 304=4, the data description 401 represents “AUDIO”.

vi) in case where type 304=5, the data description 401 represents “VIDEO”.

vii) in case where type 304=6, the data description 401 represents “position information”. The position information stores coordinates of a shop associated with the URL and etc.

viii) in case where type 304=7, the data description 401 represents an “index number”. The index number will be explained later.

ix) in case where type 304=8, the data description 401 represents “scenario data”.

x) in case where type 304=9, the data description 401 represents a “scenario number”. The scenario data and the scenario number will be described later.

xi) in case where type 304=10 and after, the data description 401 is “indefinite”, a provider of the content deciding data can define the data type newly by using the above-mentioned values.

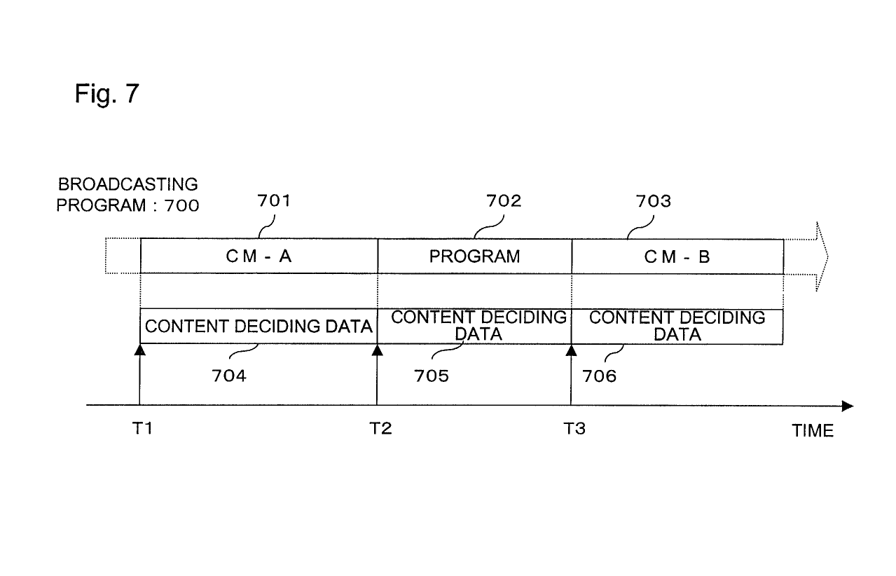

By forming the content deciding data 102 as above, it is possible to send to a user various type of data synchronizing with broadcasting programs. The broadcasting program and the content deciding data are broadcasted by the broadcasting station 100 in the following way by using the configuration of the content deciding data. That is to say, as shown in FIG. 7, when a commercial A (CM-A701) composing the broadcasting program 700 has a starting time T1 and a finishing time T2, the T1 is registered in First_PTS 100 of the content deciding data 704 while the T2 in Last_PTS 100 of the content deciding data 704, and then the broadcasting program 700 is broadcasted. Besides, the data 306 in the content deciding data 704 stores a URL associated with the commercial A, for example. Likewise, regarding the content deciding data 705 corresponding to the program 702 composing broadcasting program 700, the First_PTS 100 stores T2 and the Last_PTS 101 stores T3. The real content data 306 of the content deciding data 705 stores a URL associated with the program 702, for example. In addition, for instance, a plurality of content deciding data may be changed and sent (multiplexed) in the middle of broadcasting a commercial.

The content deciding data 102 thus configured is broadcasted as broadcasting data from the broadcasting station 100 after being multiplexed with the broadcasting program, which is the same as that of prescribed description.

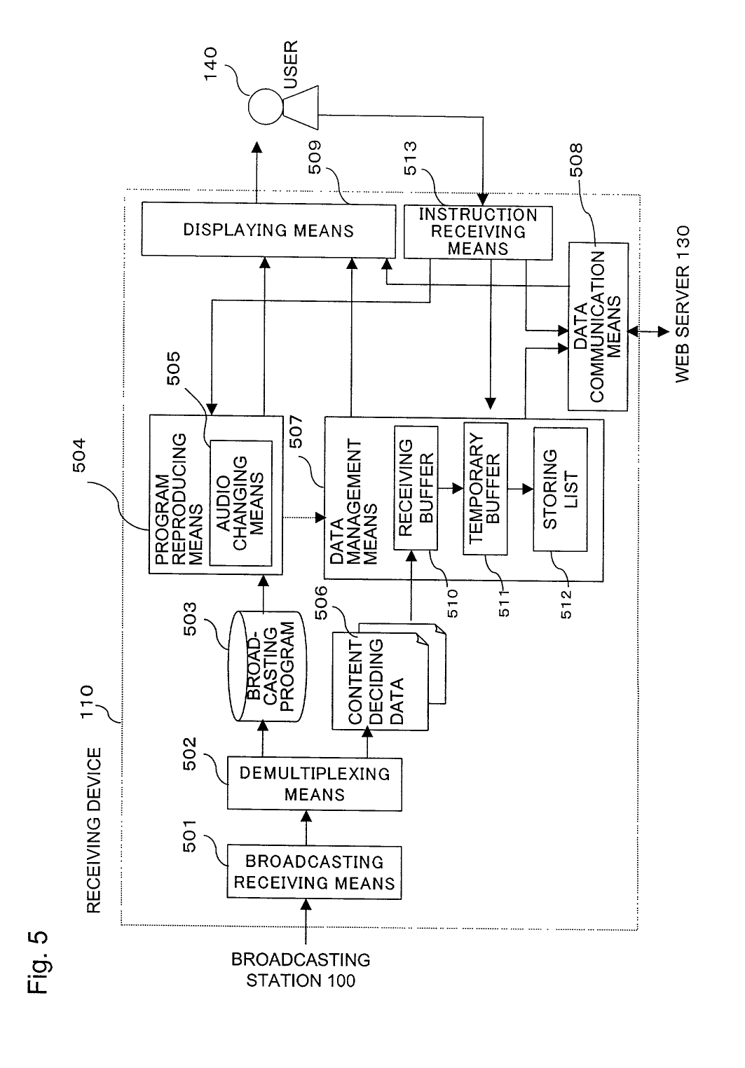

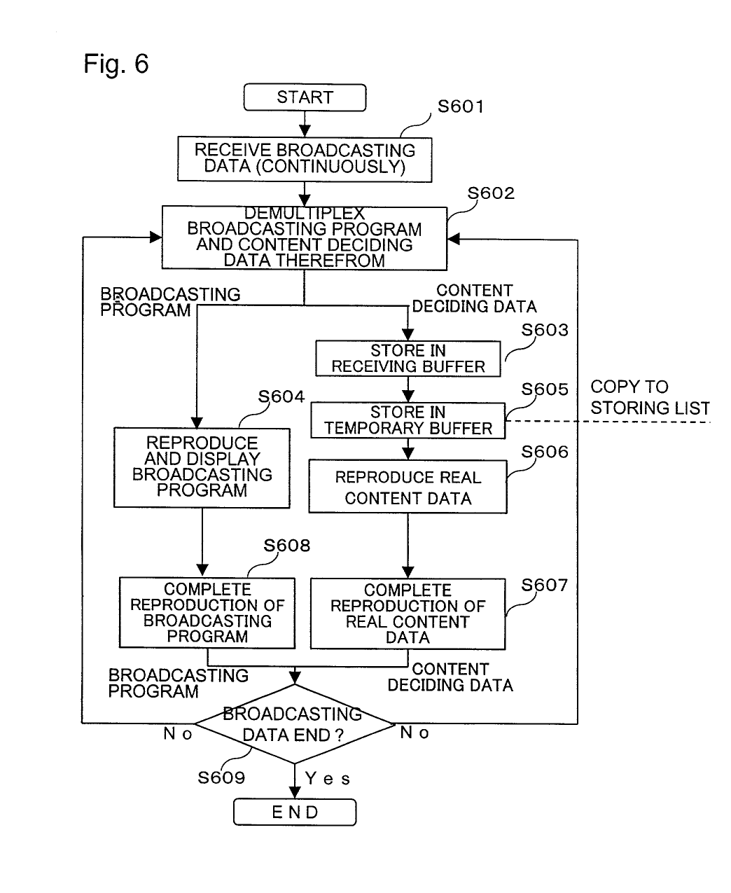

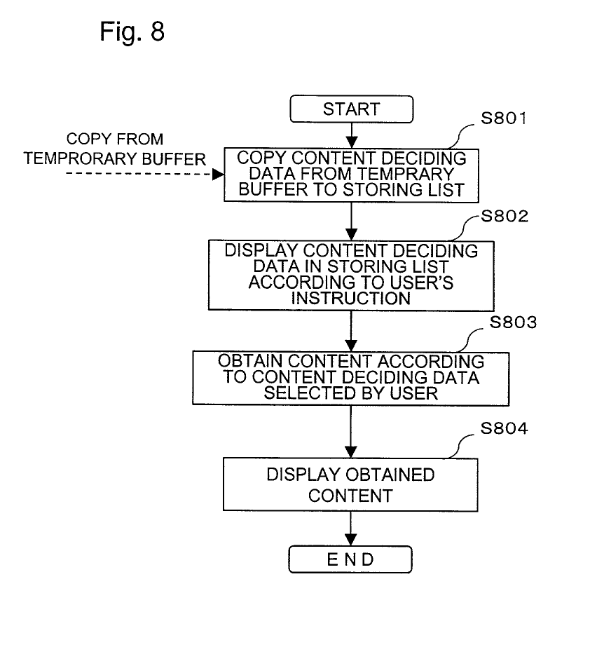

According to FIG. 5, FIG. 6, FIG. 7, and FIG. 8, the following explains in detail about the processing after the receiving device 110 receives the broadcasting data.

Broadcasting receiving means 501 composing the receiving device 110 receives the broadcasting data broadcasted from the broadcasting station 100, and sends the broadcasting data to demultiplexing means 502 (S601, FIG. 6). Next, according to the method corresponding the processing of the multiplexing means 103 of the broadcasting station 100, the demultiplexing means 502 receiving the broadcasting data demultiplexes the broadcasting program 503 and the content deciding data 506 that are included in the broadcasting data (S602, FIG. 6).

Next, the demultiplexed content deciding data 506 is stored temporarily in a receiving buffer 510 composing the data management means 507 (S603, FIG. 6).

In addition, the demultiplexed broadcasting program 503 is sent to program reproducing mean 504 without change. The program reproducing mean 504 reproduces the received broadcasting program according to the format of the broadcasting program, and then display the reproduced program through a displaying means 509 such as a display (S604, FIG. 6).

The following refers to a case where the broadcasting program 700 shown in FIG. 7 is reproduced practically. For instance, the time when the program reproducing means 504 starts to reproduce CM-A701 of the broadcasting program 700 is T1 shown in FIG. 7. The time T1 represents a time immediately after the broadcasting receiving means 501 receives the CM-A701, for example.

On the other hand, the data management means 507 reads out the First_PTS 300 and the Last_PTS 301 of the content deciding data 704 stored in the receiving buffer 510. It is the time T1 that is stored in the First_PTS 300, while the time T2 that is stored in the Last_PTS 301. Accordingly, when it comes the time T1, the data management means 507 transfers the content deciding data 704 to the temporary buffer 511 and displays on the displaying means 509 the real content data stored in the data 306 of the content deciding data 704 (S605 to S606, FIG. 6).

According to the above steps, the CM-A701of the broadcasting program 700 and the real content data stored in the data 306 of the content deciding data 704 (URL, for example) are displayed at one time on the displaying means, so that a user can watch and listen to the broadcasting program and the real content data associated with the broadcasting program. The content deciding data stored in both the receiving buffer 510 and the temporary buffer 511 is abandoned by the data management means 507 when it comes the time T2. Unless the broadcasting data is ended, the steps start again from demultiplexing the content deciding data from the broadcasting data (S607 to S609 NO to S602, FIG. 6). It is natural that the reproduction of the broadcasting program will be ended immediately after the time T2, and if there is next broadcasting program, the program is reproduced in sequence according to the above steps (S608 to S609 to S602, FIG. 6).

It is possible to store video (moving images or static images), audio, or URL as the real content data stored in the content deciding data. Except such data, if a plurality of real contents included in the content deciding data is combined each other, it is possible to display the video, the audio, and the URL combining each other. However, the content deciding data has to comprise at least one URL or a group of the keywords that can decide a position of content.

The next description refers to a case where a user 140 has his interest in the substance of the broadcasting program while watching and listing the broadcasting program (a commercial, for example). The user presses down a specific button provided in the receiving device 110, which instructs instruction receiving means 513 to register the content deciding data (to make a bookmark), the instruction receiving means 513 composing the receiving device 110. Thus instructed instruction receiving means 513 sends the receipt of the instruction to the data management means 507, and the data management means 507 registers in the storing list 512 the content deciding data stored in the temporary buffer 511 when the specific button is pressed down (S801, FIG. 8).

Accordingly, when a user takes his interest in the broadcasting program while watching the broadcasting program, it becomes easy for a user to store as a bookmark the content deciding data (URL, for example) associated with the broadcasting program instead of using the keyboard, and etc.

The content deciding data stored in the storing list 512 is utilized as follows. The user 140 presses the specific button to select the content deciding data stored in the storing list 512. Pressing the button is informed to the data management means 507 through the instruction receiving means 513, and the data management means 507 displays on the displaying means 509 all the contents deciding data stored in the storing list 512 (S802, FIG. 8). After looking through the displayed list, the user selects a desired one from the displayed content deciding data pressing down a crossing key or the like, and presses down the specific deciding button. Pressing the deciding button is informed to data communication means 508 through the instruction receiving means 513, and the data communication means accesses to a WEB server 130 according to the selected content deciding data, thereby the content corresponding to the content deciding data can be obtained (S803, FIG. 8). The obtained content is displayed on the displaying means 509, consequently the user can browse the content corresponding to the content deciding data stored in the storing list 512 (S804, FIG. 8). It is possible to apply the conventional method to the procedure of displaying the content on the displaying means 509 after the data communication means 508 obtains the content from the WEB server 130, therefore the explanation is not made here.

As described above, it is easy for a user to obtain the content deciding data (URL, for example) with a simple operation of pressing a button instead of using inputting means like a keyboard, and to access to the content corresponding to the content deciding data. Therefore, the user need not to remember the URL for the inputting, so that the invention can introduce the settlement of the problem of transferring a URL as described above. Moreover, since the user needs not to remember a URL or take a note of the URL, there is no possibility that the user is interrupted while watching the broadcasting program.

Besides, the content deciding data isn't restricted to the URL, but may be a group of plural keywords or a specific numerals string, for example. In this case, the data communication means 508 temporarily sends the obtained content deciding data to a WEB server provided with a specific database, and then accesses to the specific content according to the URL obtained from the WEB server.

Moreover, the First_PTS 100 may store an ID that can be associated only with a broadcasting program, instead of the time. In this case, at the time of reproducing the broadcasting program, the program reproducing means 504 sends to the data management means 507 the broadcasting program ID included in the broadcasting program to be reproduced. And then, the data management means 507 selects the content deciding data corresponding to the received ID from the receiving buffer 510, which is copied to the temporary buffer 511. Thereby the broadcasting data and the content deciding data can be displayed at a time. Using the ID make it possible to process the broadcasting data in the same way as that of reproducing the broadcasting program as it is after receiving the program, even if the broadcasting data has been recorded before. And when the ID is stored in the First_PTS 100, the Last_PTS 101 is not always required.

After the content deciding data is stored in the storing list 512 temporarily according to the user's instruction, the corresponding data is obtained. However, instead of storing the content deciding data in the storing list 512 temporarily, the content may be obtained direct from the WEB server according to the content deciding data stored in the temporary buffer 511 at the user's instruction.

The content deciding data is not always to be displayed on the displaying means 509.

### Embodiment 2

Here is explained about a receiving device in the embodiment 2 according to FIGS. 4, 5, 9 and 10. In the embodiment 2, the content deciding data is selected and obtained from a plurality of broadcasted content deciding data according to the audio of the broadcasting program that a user is watching. And the embodiment 2 has many points that are common to that of the embodiment 1, which of those points are not described here.

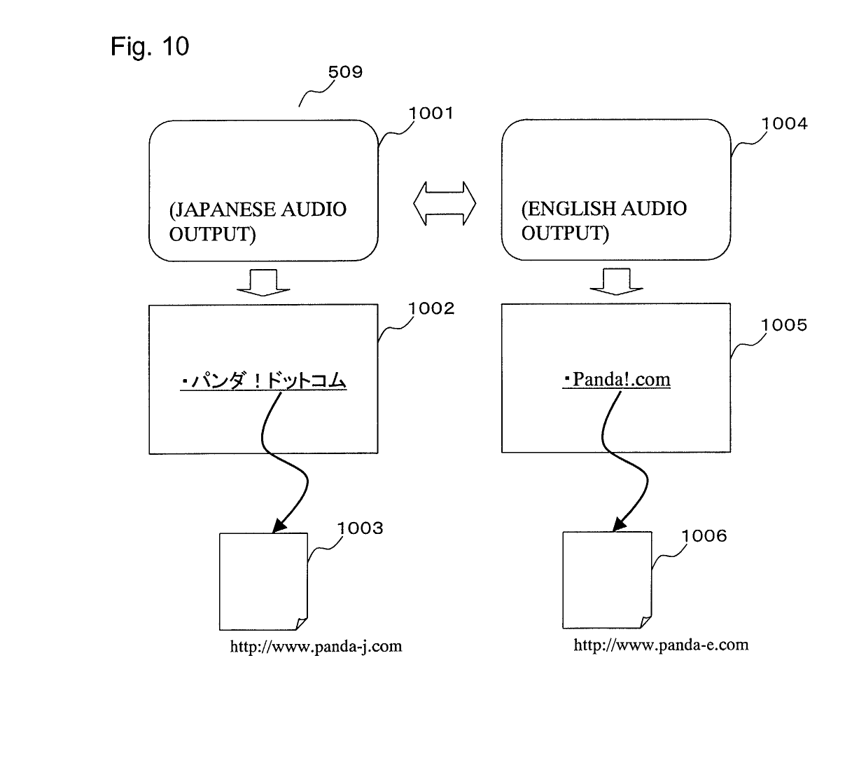

Before explaining the embodiment 2 in detail, here is given the outline about the processing of selecting and obtaining the content deciding data according to the audio. FIG. 10 shows an example displayed by the displaying means 509 of the receiving device 110, wherein at a display 1001 the Japanese audio (main-audio) is outputted, and at the display 1004 the English audio (sub-audio) is outputted. It is possible for the user to select either the output of Japanese audio or the output of English audio. When the user obtains the URL of the content deciding data during the outputting of the Japanese audio, for example, the Japanese explanation and the URL 1003 of the Japanese homepage (http://www.panda-j.com) shown in a display 1002 can be obtained automatically. The obtained explanation and homepage are added with a bookmark, for example, or the content corresponding to the URL is obtained direct from the WEB server. Likewise, when the user obtains the URL of the content deciding data during the outputting of the English audio, for example, the English explanation and the URL of the English homepage (http://www.panda-j.com) shown in a display 1005 can be obtained automatically. The obtained explanation and homepage are added with a bookmark, for example, or the content corresponding to the URL is obtained direct from the WEB server.

The above-mentioned description is the outline of the function provided to the receiving device in the embodiment 2.

In order to select and obtain the content deciding data according to the audio, the configuration of the prescribed content deciding data will be explained as follows.

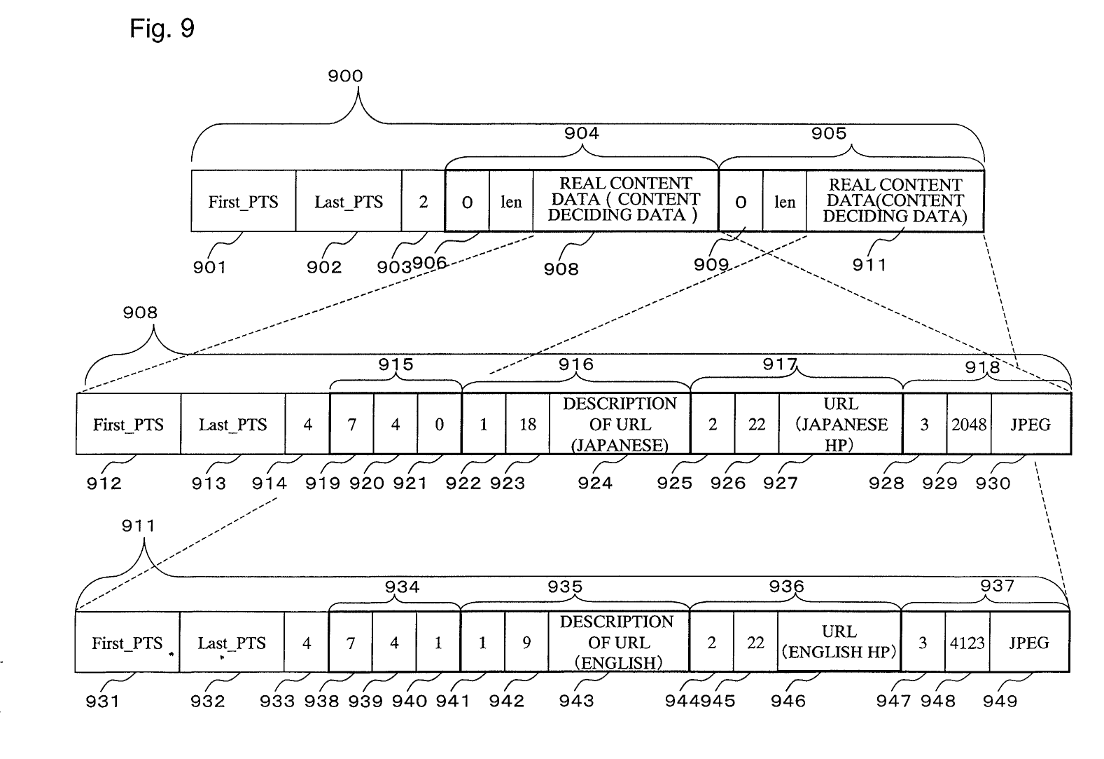

In FIG. 9, the content deciding data 900 comprises a First_PTS 901 and a Last_PTS 902 that represent the valid time of the content deciding data 900, and further comprises real contents 904 and 905. The real content 904 stores in a format of the content deciding data a URL associated with the Japanese homepage corresponding to the Japanese audio, which is the main-audio. On the other hand, the real content 905 stores in a format of the content deciding data a URL associated with the English homepage corresponding to the English audio, which is the subaudio. Therefore, the number of real contents 903 in the content deciding data 900 stores “2”, and respective types of real content 906 and 909 store “0” indicating that the real content data 908 and 911 are the content deciding data.

The next explanation refers to the configuration of the real content data 908 and 911 in the real contents 904 and 905.

The First_PTS 912 and the Last_PTS 913 composing the content deciding data 908 stores same values as those of the First_PTS 901 and the Last_PTS 902 composing the content deciding data 900.

As shown by the value of the number of real contents 914 that is “4”, the real content data 908 stores four real contents, that is, real contents 915, 916, 917, and 918.

The real content data 921 in the real content 915 is the index number as shown by the value of the type of real content 919 that is “7”. The length of real content 920 stores “4”, which means the real content data 921 is 4 bytes. Besides, the value of the data 921 is “0”. The value “0” is predetermined to be corresponding to the main-audio (Japanese audio broadcasting) (index type 402 in FIG. 4).

The real content data 924 in the real content 916 is the explanation of URL as shown by the value of the type of real content 922 that is “1”. The length of real content of the explanation of URL 923 is “18”, therefore the explanation of URL is 18 bytes, and is represented by [symbol] ! [symbol] in Japanese that means “Panda!.com” in English.

The real content data 927 in the real content 917 is URL as shown by the value of the type of real content 925 that is “2”. The length of real content of the URL is “22”, which means that the URL is 22 bytes. Besides, the real content data 927 is inscribed with “http://www.panda-j.com” indicating the position of the Japanese homepage.

The real content data 930 in the real content 918 is JPEG (an image file) as shown by the value of the type of real content 928 that is “3”. The length of real content 929 of the JPEG is “2048”, therefore the JPEG is 2048 bytes. The JPEG is images associated with the URL indicating the Japanese homepage, for example. After adding the URL to the bookmark, the image is displayed as an icon indicating the URL. That is to say, a user can understand intuitively what is the book-marked URL according to the image.

The above descriptions refer to the configuration of the content deciding data 908 corresponding to the main-audio.

Here is explained about the content deciding data 911. The First_PTS 931 and the Last_PTS 932, those composing the content deciding data 911, stores the same values as those of the First_PTS 901 and the Last_PTS 902 of the content deciding data 900.

As shown by the value of the number of real content data 933 that is “4”, the real content data 911 stores four real contents, that is, real contents 934, 935, 936, and 937.

The real content data 940 in the real content 934 is the index number as shown by the value of the type of real content 938 that is “7”. The length of real content 939 of the index is “4”, therefore the real content data is 4 bytes. The real content data 940 is “1”, which is predetermined so as to be corresponding to the English audio broadcasting as the sub-audio (index type in FIG. 4).

The real content data 943 in the real content 935 is an explanation of URL as shown by the value of the type of real content that is “1”. The length of real content 942 of the explanation of URL is “9”, therefore the explanation of URL is 9 bytes. The value is inscribed with “Panda!.com” in English.

The real content data 946 in the real content 936 is a URL as shown by a value of the type of real content 944 that is “2”. The length of real content 945 of the URL is “22”, which means the URL is 22 bytes. Besides, the real content 946 is inscribed with “http://www.pand-e.com” indicating the English homepage.

The real content data 949 in the real content 937 is JPEG (an image file) as shown by the value of the type of real content 947 that is “3”. The length of real content 948 of the JPEG is “4123”, therefore the JPEG is 4123 bytes. The JPEG is images associated with the URL indicating the English homepage, for example. After adding the URL to the bookmark, the image is displayed as an icon indicating the URL. That is to say, a user can understand intuitively what is the book-marked URL according to the image, in the same way of that of the content deciding data 908.

The above explanation refers to the configuration of the content deciding data 911 corresponding to the sub-audio.

Under the above configuration of the content deciding data, the following explains in detail about the processing of selecting and obtaining the content deciding data according to the audio of the broadcasting program that a user is watching.

In the embodiment 2, audio changing means 505 is provided with the program reproducing means 504 shown in FIG. 5. The audio changing means 505 changes between the main-audio and the sub-audio at the time of the audio multiplexing broadcasting. The embodiment 2 is assumed that the broadcasting station 100 broadcasts the Japanese audio as the main-audio and the English audio as the sub-audio. The content deciding data comprises two kinds of URL (real content data 927 and 946) as shown in the content deciding data 900.

The audio changing means 505 changes between the Japanese audio and the English audio according to a user's selection, and notices the program reproducing means 504 of the selected audio type. The program reproducing means 504 outputs the audio corresponding to the selected one from a speaker that is not shown in the drawing, and at the same time sends to the data management means 507 the audio type being outputted. Specifically, if the audio being outputted at the present time is the main-audio (the Japanese audio), “0” is registered in the data management means 507, meanwhile, if the sub-audio (the English audio), “1” is registered.

When the received audio type is “0”, the data management means 507 selects the content deciding data 908 wherein the type of real content is “7(index no.)” and the real content data is “0”. In result, the selected content deciding data is to comprise the URL of the Japanese homepage (the real content data 927) and the real contents 916 and 918 attending with the URL of the Japanese homepage.

When the received audio type is “1”, the data management means 507 selects the content deciding data 911 wherein the type of real content is “7(index number)” and the real content data is “1”. In result, the selected content deciding data is to comprise the URL of the English homepage (the real content data 936) and the real contents 935 and 937 attending with the URL of the English homepage.

After selecting the content deciding data, the data management means 507 copies the selected content deciding data from the receiving buffer 510 to the temporary buffer 511. Specifically, the data management means 507 copies the content deciding data 908 including the URL of the Japanese homepage if the audio type received from the program reproducing means 504 is the Japanese audio (the main-audio), or copies the content deciding data 911 including the URL of the English homepage if the audio type received from the program reproducing means 504 is the English audio (the main-audio), from the receiving buffer 510 to the temporary buffer 511.

After the specified content deciding data is copied to the temporary buffer 511, the substance of the content deciding data is displayed on the displaying means 509. The steps of obtaining the corresponding content from the data communication means 508 by the user's instruction is the same as that of the embodiment 1. Consequently, the content deciding data corresponding to the audio type (URL, in this case) is book-marked according to the user's instruction.

As described above, while the program reproducing means 504 sends to the data management means 507 the audio type being reproduced at the present time, the data management means 507 selects a specified content deciding data from a plurality of content deciding data according to the audio type. Therefore, the user can obtain the URL (the content deciding data) corresponding to the audio type of the broadcasting program that the user is watching, and also can access to the homepage indicated by the URL in ease.

Besides, if VIDEO and AUDIO are added to real content data by using the content deciding data, it is possible to display the VIDEO on the displaying means and reproduce the AUDIO. By reproducing the VIDEO or the AUDIO as an icon of the bookmark, the user can understand immediately which bookmark is corresponding to the information.

### Embodiment 3

The following refers to a receiving device in the embodiment 3 according to FIGS. 5, 11, 12 and 13. The embodiment 3 explains the arrangement that the intention of the content-provider makes a user access to the content by using a plurality of content deciding data (URL) deciding the position of content and scenario data representing the order of the use of the plurality of content deciding data.

Before explaining the processing in detail, here is explained about the configuration of the content deciding data to make a user access to the content according to the intention of content-provider. The explanation will not refer to the configuration that is same as that of the embodiment 1 or the embodiment 2.

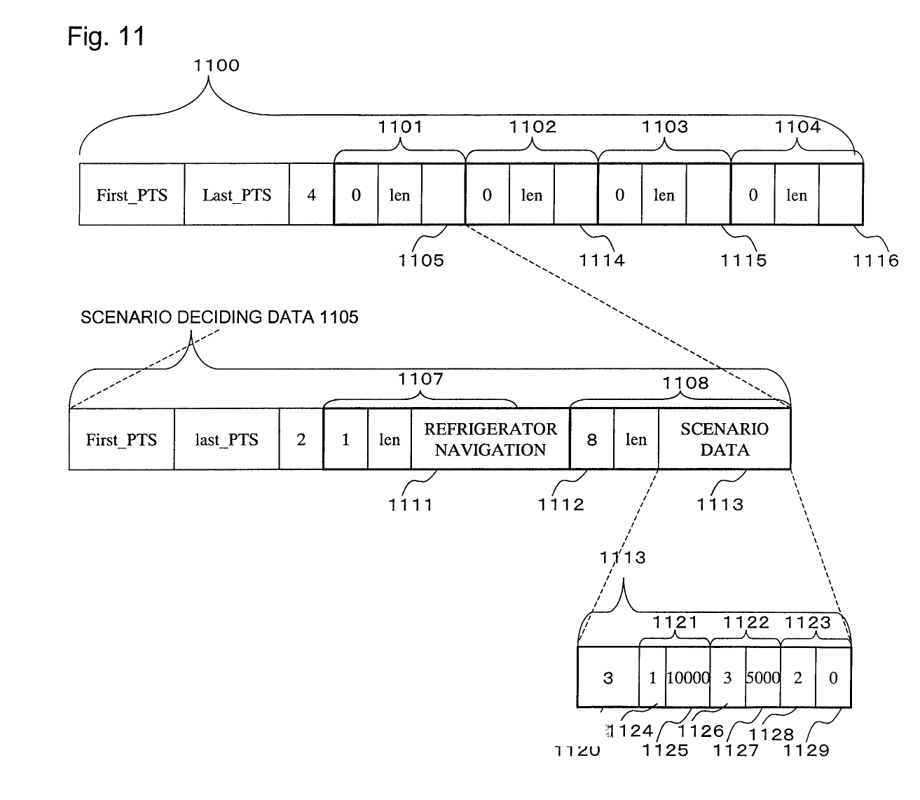

The content deciding data 1100 shown in FIG. 11 further stores a plurality of content deciding data and scenario data describing the order of the use of those URLs. That is to say, the real content data 1105 in the real content 1101 composing the content deciding data 1100 comprises the real content 1107 including the explanation of the URL and the real content 1108 including the scenario data. That is to say, the real content 1108 is the scenario data. The real content data in the real contents 1102, 1103 and 1104 stores respective URLs different each other.

The real content 1107 is the explanation of URL. However, since the real content 1108 is the scenario data as described later, the real content data 1111 in the real content 1107 is used as the explanation of scenario. The explanation of URL is inscribed in Japanese and means “refrigerator navigation”.

The real content 1108, wherein the type of the real content 1112 is “8”, indicates that the real content data 1113 is the scenario data.

The real content data 1113 (the scenario data) is composed of the number of scenario items 1120 and scenario items 1121, 1122 and 1123. The number of scenario items 1120 represents the number of the scenario items, and the value of the scenario data 1113 is “3”. The scenario items 1121, 1122 and 1123 are composed of the scenario numbers 1124, 1126 and 1128 and the displaying time 1125, 1127 and 1129, respectively. The displaying time is stored in a unit of millisecond. For instance, in the scenario item 1121, the scenario number is “1” and the displaying time 1125 is 10000 millisecond. However, a case where the value of the displaying time is “0” will be explained late.

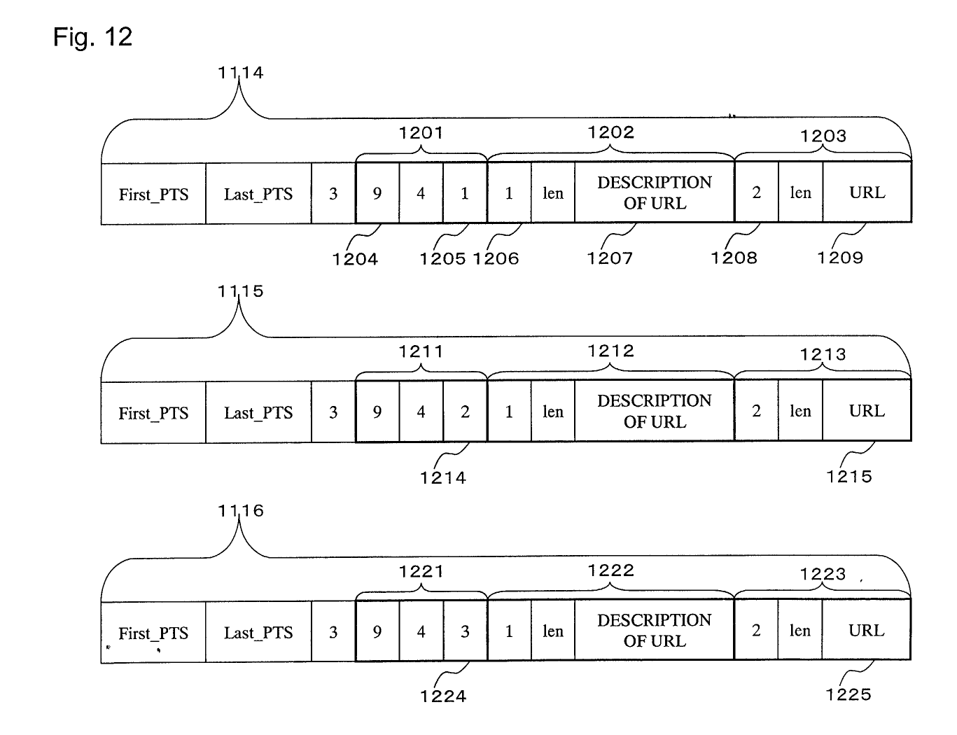

With reference to FIG. 12, the following explains about the configuration of the real content data 1114, 1115 and 1116 in the real content 1102, 1103 and 1104.

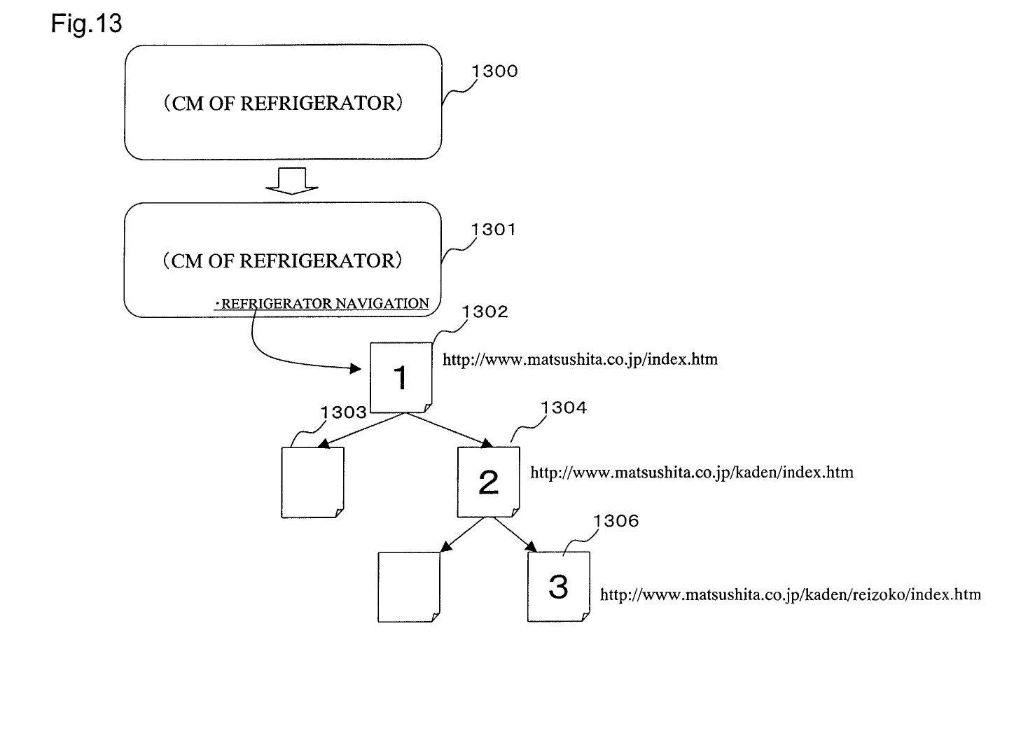

The real content data 1114 is configured in a format of content deciding data. As shown by the value of the number of real contents 1200 that is “3”, the real content data 1114 stores three real contents, real contents 1201, 1202, and 1203. The type of real content 1209 of the real content 1201 is “9”, therefore the real content data 1205 is the scenario number. The scenario number represents the order of accessing to the URL (the real content 1209) included in the content deciding data corresponding to the scenario number (the content deciding data 1114). In the real content data 1205 corresponding to the scenario number, the value “1” is stored. In the real content 1202, the type of real content 1206 has a value “1”, therefore the real content data 1207 is the explanation of URL. In the real content 1203, the type of real content 1208 has the value “2”, therefore the real content data 1209 is a URL. Here, the URL is inscribed with “http://www.matsushita.co.jp/”. The URL indicates a top page 1302 of the homepage of a specific company as shown in FIG. 13.

The configuration of the content data 1115 and 1116 is the same as that of the real content data 1114, but the real content data 1214 in the real content 1211 stores “2” as the scenario number while the real content data 1224 in the real content 1221 stores “3” as the scenario number.

The real content data 1215 in the real content 1213 stores “http://www.matshushita.co.jp/kaden/index.htm” as the URL. The URL indicates the homepage 1304 introducing consumer electric goods of a specific company.

The real content data 1225 in the real content 1223 stores “http://www.matshushita.co.jp/kaden/reizoko/index.htm” as the URL. The URL indicates the homepage 1306 introducing refrigerators of a specific company.

According to FIG. 13, the configuration of a homepage of a specific company is explained hereafter. The URL of top page 1302 is “http://www.matsushita.co.jp/”, which indicates a top page of a specific company. A homepage 1303 and a homepage 1304 are linked with the top page 1302.

The URL of the home page 1304 is “http://www.matshushita. co.jp/kaden/index.htm”, and indicates the page introducing consumer electric goods of the specific company.

The URL of the homepage 1306 is “http://www.matshushita. co.jp/kaden/reizoko/index.htm”, and indicates the page introducing refrigerators of consumer electric goods provided by the specific company.

Considering the configuration of the content deciding data and that of the homepage of a company, the processing of the receiving device 110 is explained here.

As shown as a displaying example in FIG. 13, in case where a user 140 watches a commercial of a refrigerator of the company that is the substance of the broadcasting program, for example, the commercial is multiplexed with the content deciding data 1100 shown in FIG. 11. While broadcasting the commercial, the displaying means 509 displays “refrigerator navigation” as shown as a displaying example 1301. At this time, the content deciding data 1100 is stored in the temporary buffer 511, like that in the embodiment 1. The letters of the “refrigerator navigation” are included in the real content data 1107.

When the user has his interest in the commercial and wants to refer to the URL publishing the explanation of the refrigerator, for example, the user 140 can obtain the content deciding data 1100 via the broadcasting program, like that described in the embodiments 1 and 2.

The obtained content deciding data 1100 is stored in a storing list 512 temporarily. The content deciding data 1100 obtained here stores the top page 1302, the homepages 1304 and 1306, and the URLs of the top page and the homepages are stored in the content deciding data 1114, 1115, 1116 respectively, while the scenario data indicating the order of displaying is stored in the scenario deciding data 1105.

The content deciding data 1100 stored in the storing list 512 is read out by the data management means 507, which is sent to the data communication means 508 in order that the receiving device accesses to the WEB server 1130. Here the following processing is performed.

Specifically, the data management means 507 refers to the type of real content 1112 in the scenario deciding data 1105, and then obtains the scenario data (the real content data) 1113. Next, the data management means 507 obtains the scenario number 1124 and the displaying time 1125 in the scenario data 1113, and at the same time obtains the content deciding data corresponding to the scenario number 1124. The one “corresponding to the scenario number 1124” is the content deciding data 1114 wherein the type of real content is “9(the scenario number)” and the real content data is “1”.

The data management means 507 sends the content deciding data 1114 and the displaying time 1125 to the data communication means 508, and then the data communication means 508 accesses to the top page 1302 by using the URL stored in the content deciding data 1114, that is, “http://www.matsuhita.co.jp/kaden/index.htm”. According to the above process, the receiving device 110 can obtain a first content. Besides, the displaying means 509 performs the displaying for 10000 milliseconds based on the displaying time 1125.

While the displaying means 509 is displaying the first content, the data management means 507 reads out the scenario number 1126 following to the scenario number 1124 in the scenario data 1113, and then obtains the scenario number “2” and the displaying time 1127. After that, the data management means 507 obtains the content deciding data 1115 corresponding to the scenario number 1126 in like manner, and sends to the data communication means 508 the content deciding data together with the displaying time 1127.

The data communication means 508 accesses to the homepage 1304 according to the received content deciding data 1115, thereby the data management means 508 obtains a second content and the displaying means displays the content for the time indicated by the displaying time 1127.

Likewise, the data communication means 508, which receives the content deciding data 1116 and the displaying time 1129 sent from the data management means 507, accesses to the homepage 1306 according to the content deciding data 1116, thereby the data management means 508 obtains a third content and the displaying means 509 displays the content for the time indicated by the displaying time 1129. However, since the displaying time 1129 has a value “0”, the displaying means 509 does not perform the change of display but continues to display the home page 1306. Besides, the third content is the homepage that the user 140 aims at.

As described above, it is possible to settle the problem of transfer of URL by sending the plural URLs together with the scenario data describing the order of use of the URLs, and it is also possible for the intention of the content provider to make a user access to a specific content.

Therefore, according to the invention, the user is sure to arrive at the homepage that he took his interest in. In addition, the invention can make a user browse a homepage concerning with not only the refrigerator but also other consumer electric goods, or recommendable homepage for the benefit of the company that provides the homepage. In result, the invention can settle the above detour route problem.

### Embodiment 4

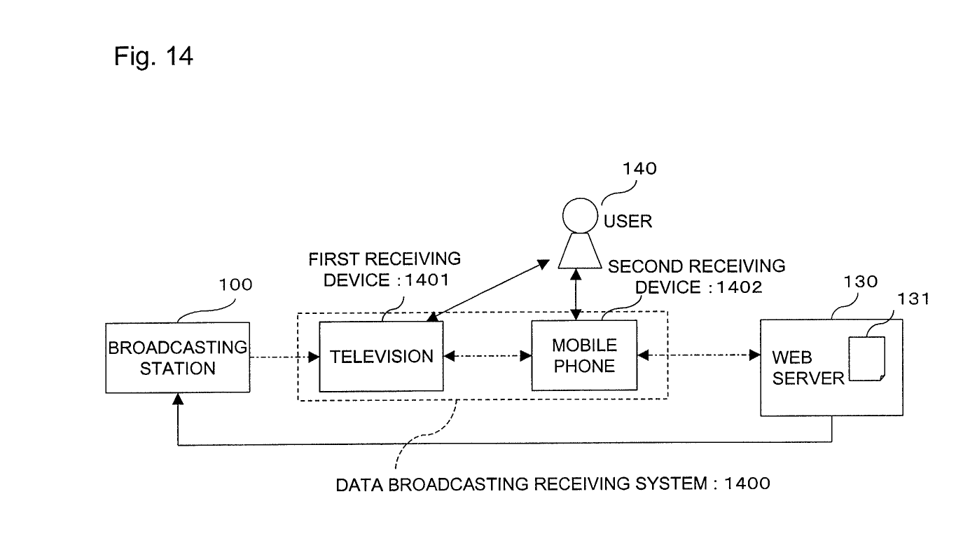

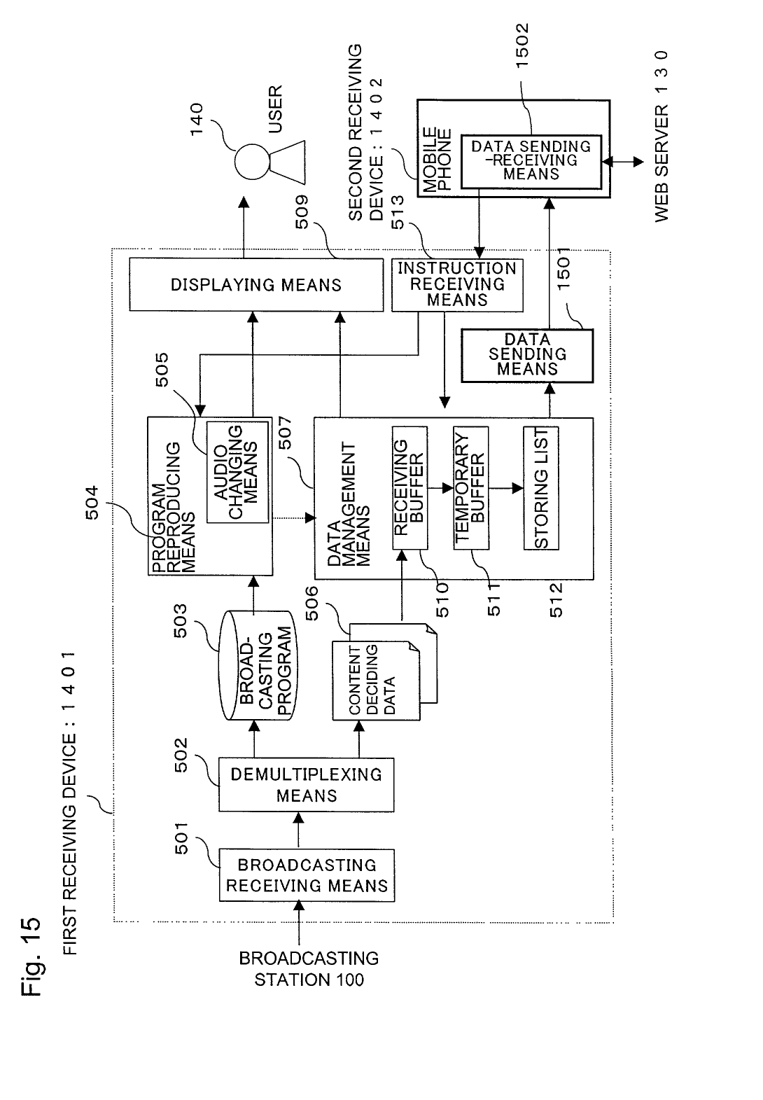

With reference to FIGS. 14 and 15, here is explained about the data broadcasting receiving system in the embodiment 4. The data broadcasting receiving system 1400 comprises a first receiving device 1401 and a second receiving device 1402.

The first receiving device 1401 is a television or the like, in a material way, which can receive broadcasting programs. The first receiving device is configured as same as the receiving device 110 described in the embodiments 1 and 2, and further provided with data sending means 1501. However, the first receiving device does not always have to be provided with the Internet connecting function.

The second receiving device 1402 is a mobile phone or the like, in a material way, which is provided with the Internet connecting function. And the second receiving device 1402 is provided with data sending-receiving means 1502 that can receive the content deciding data from the data sending means 1501 of the first receiving device 1401. Besides, it is possible to apply the infrared transmission or the wireless transmission between terminals such as the Bluetooth, for example, to the transmission between the data sending means 1501 and the data sending-receiving means 1502.

The broadcasting program broadcasted from the broadcasting station 100 is multiplexed with the content deciding data, which is transmitted as the broadcasting data. The broadcasting data received by the first receiving device 1400 is demultiplexed to the broadcasting program and the content deciding data, which are displayed on the displaying means 509. The steps up to now are the same as that of the embodiments 1 to 3.

When the user 140 takes his interest in the broadcasting program, the instruction to obtain the content deciding data corresponding to the broadcasting program is informed to the second receiving device 1402 by pressing down a specific button provided in the second receiving device 1402.

The second receiving device 1402 receiving such instruction sends the instruction to the first receiving device 1401 via the data receiving device 1502.

The instruction receiving means 513 receiving the instruction sends the instruction to the data management means 507, and the data management means 507 sends the content deciding data store in the temporary buffer 511 to the data sending means 1501. Besides the content deciding data stored in the temporary buffer 511 is the one that had been displayed on the displaying means 509 when the user 140 pressed the specific button.

The data receiving means 1501 receiving the content deciding data sends the content deciding data to the data sending-receiving means 1502.

The data sending-receiving means 1502 receiving the content deciding data registers the content deciding data in the bookmark, and then accesses to the WEB server 130 according to the content deciding data.

According to the above configuration, the user can obtain the content deciding data (URL, for example) with the simple operation by pressing a button instead of using the inputting means like the keyboard, and also access to the content corresponding to the content deciding data. Accordingly the user does not need to remember the URL for the inputting; thereby it is possible to settle the problem of transferring the URL.

It is easy for even the receiving device like a mobile phone required to be downsized passionately, which is difficult to comprise the function of receiving the broadcasting program, to be provided with the data sending-receiving device enable to receive not more than the content deciding data.

The above configuration can be applied to the case where many and unspecified persons obtain the content deciding data by using the mobile phone from the broadcasting program that is displaying on the street display, by which everyone can browse the broadcasting program. In this application, the many and unspecified persons can display on each mobile phone the content corresponding to the broadcasting program that they are watching at the present time with pressing down a button, for example.

The data sending-receiving means 1502 receives the content deciding data according to the instruction of the user 140, however, the invention may be arranged that the data sending-receiving means always receive the content deciding data sent from the second receiving device 1401, and then access to the WEB server 130 according to the instruction of the user 140.

The second receiving device can be placed with a PDA, or a personal computer.

According to the receiving device and the data broadcasting receiving system described above, a user can obtain content deciding data with a simple operation of pressing a button instead of using the inputting means like the keyboard, and access to the content corresponding to the content deciding data. Therefore, the user does not need to remember the URL for the inputting, and it is possible to settle the problem of transfer of URL.

In addition, the content deciding data that is obtained by a user under specific conditions (the audio type, for example) can be changed automatically, simultaneously the user can obtain the content deciding data corresponding to the audio of the broadcasting program that the user is watching, and then access to the homepage indicated by the URL easily.

Moreover, the intention of a content-provider can make a user access to specific content; therefore the user can certainly arrive the homepage that he took his interest in.

Furthermore, it is possible to make a user browse other homepages for the benefit of companies that provide the homepage. Consequently, it is possible to settle the problem of detour route.

What is claimed is:

1. A receiving device receiving broadcasting programs, which comprising:
broadcasting receiving means for receiving broadcasting data in which content deciding data is multiplexed with a broadcasting program associated with said content, the content deciding data deciding a position of content placed on the network;
demultiplexing means for demultiplexing the content deciding data and the broadcasting program from the broadcasting data received by the broadcasting receiving means; and
data communication means for accessing to the content based on the content deciding data demultiplexed by the demultiplexing means.

2. A receiving device according to claim 1,
in which the demultiplexing means demultiplexes a plurality of content deciding data respectively from the broadcasting data when there is a plurality of the content deciding data in the broadcasting data;
which further comprising:
data management means for selecting one or more content deciding data from a plurality of content deciding data demultiplexed by the demultiplexing means according to a specific condition; and,
in which the data communication means accesses to the contents based on the content deciding data selected by the data management means.

3. A receiving device according to claim 2, wherein the specific condition is an audio type selected by the receiving device.

4. A receiving device according to claim 1,
in which the demultiplexing means demultiplexes a plurality of content deciding data and scenario data respectively from the broadcasting data when there are a plurality of the content deciding data and scenario data indicating the order of using the content deciding data in the broadcasting data;
which further comprising:
data management means for selecting in sequence content deciding data from a plurality of content deciding data demultiplexed by the demultiplexing means according to the scenario data demultiplexed by the demultiplexing means; and,
in which the data communication means accesses to the contents in sequence based on the content deciding data selected by the data management means.

5. A receiving device according to claim 1, wherein the content deciding data deciding a position of content placed on the network is a URL (Uniform Resource Locator).

6. A receiving device according to claim 1, wherein the content deciding data deciding a position of content placed on the network is a group of keywords.

7. A content accessing method accessing to content placed on the network, which comprising:
receiving broadcasting data in which content deciding data is multiplexed with a broadcasting program associated with said content, said content deciding data deciding a position of content on the network;
demultiplexing the content deciding data and the broadcasting program from the broadcasting data received in the step of receiving the broadcasting data; and
accessing to the content based on the content deciding data demultiplexed in the step of demultiplexing from the broadcasting data.

8. A content accessing method according to claim 7, in which the step of demultiplexing comprises demultiplexing a plurality of the content deciding data respectively from the broadcasting data when there is a plurality of the content deciding data in the broadcasting data;
which further comprising:
selecting according to a specific condition one or more content deciding data from a plurality of content deciding data demultiplexed in the step of demultiplexing; and
in which the step of accessing to the content comprises accessing to content deciding data based on the content deciding data demultiplexed in the step of selecting from the broadcasting data.

9. A content accessing method according to claim 7,
in which the step of demultiplexing comprises demultiplexing a plurality of the content deciding data and scenario data respectively from the broadcasting data when there are a plurality of the content deciding data and scenario data indicating the order of using the content deciding data;
which further comprising:
selecting sequentially a plurality of content deciding data demultiplexed in the step of demultiplexing according to the scenario data demultiplexed in the step of demultiplexing; and
in which the step of accessing to the content comprises accessing to content deciding data in sequence based on the content deciding data demultiplexed in the step of selecting from the broadcasting data.

10. A program executed by a computer accessing to content placed on the network which comprising:
receiving broadcasting data in which content deciding data is multiplexed with a broadcasting program associated with said content, said content deciding data deciding a position of content on the network;
demultiplexing the content deciding data and the broadcasting program from the broadcasting data received in the step of receiving the broadcasting data; and
accessing to the content based on the content deciding data demultiplexed in the step of demultiplexing from the broadcasting data.

11. Storage medium possible to be read by a computer storing a program executed by a computer accessing to content placed on the network, which comprising:
receiving broadcasting data in which content deciding data is multiplexed with a broadcasting program associated with said content, said content deciding data deciding a position of content on the network;
demultiplexing the content deciding data and the broadcasting program from the broadcasting data received in the step of receiving the broadcasting data; and
accessing to the content based on the content deciding data demultiplexed in the step of demultiplexing from the broadcasting data.

12. Data broadcasting receiving system which comprising a first receiving device and a second receiving device:
in which the first receiving device comprises:
broadcasting receiving means for receiving broadcasting data in which content deciding data is multiplexed with a broadcasting program associated with said content, the content deciding data deciding a position of content placed on the network;
demultiplexing means for demultiplexing the content deciding data and the broadcasting program from the broadcasting data received by the broadcasting receiving means; and
data sending means for sending the content deciding data demultiplexed by the demultiplexing means; and
in which the second receiving device comprises:
data sending-receiving means for accessing to the content based on the content deciding data received from the data sending means.
